(19) United States
(12) Patent Application Publication
(10) Pub. No.: US 2008/0060470 A1
(43) Pub. Date: Mar. 13, 2008

(54) DECORATIVE SHELLS FOR STEERING WHEELS

(76) Inventors: SAVERIO PAONESSA, Belleriver (CA); Cemal Sermet, Windsor (CA)

Correspondence Address: DYKEMA GOSSETT PLLC, 39577 WOODWARD AVENUE, SUITE 300, BLOOMFIELD HILLS, MI, 48304-5086, US

(21) Appl. No.: 11/531,108

(22) Filed: Sep. 12, 2006

(51) Int. Cl. G05G 1/10; B62D 1/04

(52) U.S. Cl. 74/558.5; 74/552

(57) ABSTRACT

An improved decorative shell covering for steering wheels is provided that enables the seams between the shells to be out of the driver's line of sight and in a position less noticeable to the touch of a driver's fingers, ensures proper placement of the shells on the wheel, and prevents movement of the shells after placement. The use of the improved covering further reduces the cost of decoration and wheel processing scrap, manufacturing costs, and transportation costs. The improved covering includes a first shell for covering a first portion of an outer surface of the wheel. The first shell may have an outer surface comprising an arc that subtends generally more than about 180° and an inner surface configured to correspond with the first portion of the outer surface of the wheel. The covering may further include a second shell for covering a second portion of the outer surface of the wheel. The second shell may be configured to be disposed adjacent to the first shell and may further have an outer surface comprising an arc that subtends generally less than about 180° and an inner surface configured to correspond with the second portion of the outer surface of the wheel. A method of covering steering wheels is also provided.

### FIELD OF THE INVENTION

This invention relates to a covering for a steering wheel, and in particular, to a decorative shell in which the outer surface of the shell comprises an arc that subtends generally more than about 180°, such that when the shell is secured to a steering wheel, the edges of the shell are out of a driver's line of sight. The invention further relates to a method for covering a steering wheel.

### BACKGROUND OF THE INVENTION

Many steering wheels in motor vehicles are decorated to provide an improved aesthetic appearance to the driver. Various processes and materials are used to improve the aesthetic appearance of the outer surface of the steering wheel in a motor vehicle. For example, the outer surface may be processed with paint, hydrographic ink coating, wood veneer, leather, in-mold film application, or numerous other processes. Decorative shells may be applied to the steering wheel in order to effectuate the improved aesthetic appearance.

Conventionally, shells that are applied to the outer surface of a steering wheel each have an outer surface that comprises an arc that subtends generally about 180° in order to ensure that each shell may be placed and secured onto a steering wheel. However, the location of the seams where the two shells meet may negatively affect the aesthetic appearance of the steering wheel and may be noticeable to the touch of the driver's fingers. Furthermore, it may be difficult to properly locate the shells on a desired portion of the steering wheel (e.g., with respect to both a general location of the shell on the wheel and the particular disposition of the edges of the shells that affect the location of the seams) and to prevent movement of the shells upon the wheel once they are attached to the wheel.

Also, in the conventional process, it is the entire molded wheel, rather than simply shells, that are decorated. Accordingly, the cost of wheel processing scrap may be quite high if the decoration process does not meet the required standards of quality since the entire molded wheel must be discarded as scrap.

Furthermore, the processing equipment that is used to provide ornamentation to the decorative shells may be expensive. Because the entire wheel must be placed in processing equipment in conventional processes, the manufacturing cost may be high since a limited number of wheels may be placed in a single application of the processing equipment.

There is a need for decorative shells for steering wheels and method for covering steering wheels that will minimize and/or eliminate the above-identified deficiencies.

### SUMMARY OF INVENTION

The present invention provides a covering for a steering wheel. The covering may include a first shell for covering a first portion of an outer surface of the wheel. The first shell may have an outer surface comprising an arc that subtends generally more than about 180° and an inner surface configured to correspond with the first portion of the outer surface of the wheel. The covering may further include a second shell for covering a second portion of the outer surface of the wheel. The second shell may be configured to be disposed adjacent to the first shell. The second shell may further have an outer surfaces comprising an arc that subtends generally less than about 180° and an inner surface configured to correspond with the second portion of the outer surface of the wheel.

The present invention further provides a method for covering a steering wheel. The method may include the following steps: providing the wheel; forming locating features in an outer surface of the wheel; providing a first shell for covering a first portion of an outer surface of the wheel; forming an inner surface of the first shell to correspond with the locating features in the outer surface of the wheel; providing a second shell for covering a second portion of the outer surface of the wheel; forming an inner surface of the second shell to correspond with the locating features in the outer surface of the wheel; forming an interlocking surface on the first and second shell; securing the first shell to the wheel; and securing the second shell to the wheel adjacent to the first shell; and securing the first and second shells to each other.

The present invention further provides a second method for covering a steering wheel. The second method may include the following steps: providing a first shell with an outer surface comprising an arc that subtends generally more than about 180°, wherein an inner surface of the first shell includes generally straight surfaces extending from the edges of the first shell; securing the first shell to the wheel; providing a second shell with an outer surface comprising an arc that subtends generally less than about 180°, wherein an outer surface of the second shell and an outer surface of the first shell combine to comprise an arc that subtends generally about 360°; and securing the second shell to the wheel adjacent the first shell.

A covering for steering wheels and methods for the same in accordance with the present invention are advantageous as compared to existing coverings for steering wheels and methods for the same. First, the use of the inventive covering enables the seams between the first and second shells to be out of the driver's line of sight, such that the wheel appears to be covered with a seamless shell, thereby improving the aesthetic appearance of the steering wheel. Second, the use of the inventive covering allows the seams between the first and second shells to be in a position that is less noticeable to the touch of a driver's fingers. Third, the use of the inventive covering ensures proper placement of the shells on the desired portion of the steering wheel and prevent movement of the shells after placement. Fourth, the use of the inventive shells reduces the cost of wheel processing scrap since it enables decoration of the less expensive shells, rather than entire molded steering wheels, thereby decreasing the cost of scrap and preventing potential damage to the steering wheel during handling. Fifth, the inventive shells further reduce manufacturing costs because the molded shells may be more compactly placed in processing equipment (for painting, hydrographic ink coating, wood veneer, leather, in-mold film application, and various other processes) than entire steering wheels. Finally, the inventive shells further reduce transportation costs since the molded shells may be more efficiently placed in shipping containers than entire steering wheels.

These and other features and objects of this invention will become apparent to one skilled in the art from the following detailed description and the accompanying drawings illustrating features of this invention by way of example.

### BRIEF DESCRIPTION OF THE DRAWINGS

FIG. 1 is a cross-sectional view of a segment of the mating of a first shell and second shell for covering a steering wheel according to the present invention.

FIG. 2 is a perspective view of the first shell of FIG. 1.

FIG. 3 is a perspective view of the second shell of FIG. 1.

FIG. 4 is a perspective view of a steering wheel according to the present invention.

FIG. 5 is a flow chart illustrating a method for covering a steering wheel in accordance with the present invention.

FIG. 6 is a flow chart illustrating another method for covering a steering wheel in accordance with the present invention.

### DETAILED DESCRIPTION OF THE INVENTION

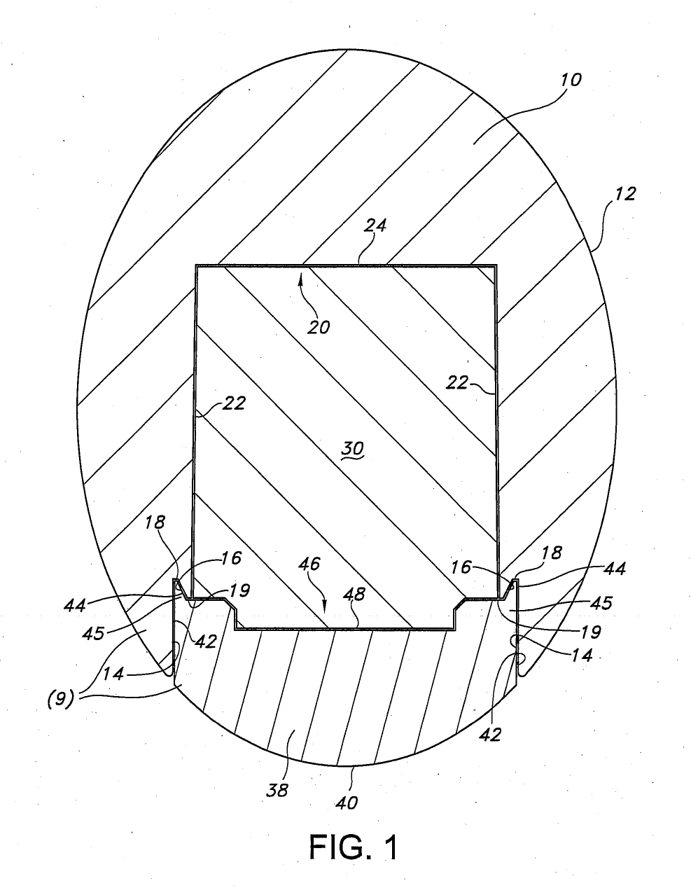

Referring now to the drawings wherein like reference numerals are used to identify identical or similar components in the various views, FIG. 1 illustrates a steering wheel covering 9 in accordance with the present invention. Covering 9 is provided to cover an outer surface of a steering wheel 30. As discussed in greater detail below, covering 9 includes a first shell 10 and a second shell 38.

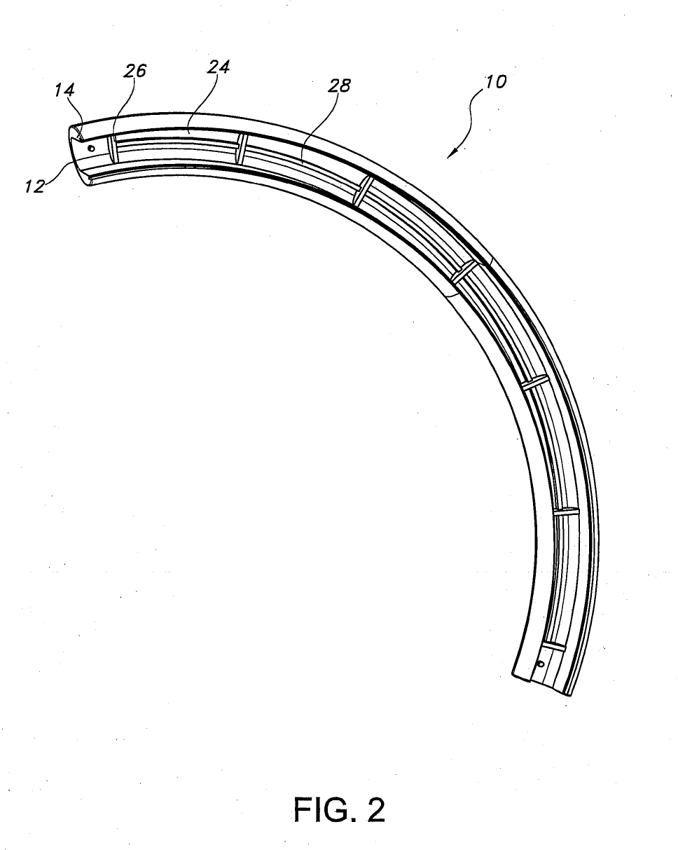

Referring now to FIGS. 1-2, first shell 10 is provided to cover a first portion of an outer surface of a steering wheel. First shell 10 may comprise a polymer. In an exemplary embodiment, first shell 10 may comprise ABS (copolymer of acrylonitrile, butadiene, and styrene), poly-carbonate ABS, nylon, or polypropylene. It should be understood, however, that material composition and method of manufacture of first shell 10 may be varied without departing from the spirit and scope of the present invention. First shell 10 may be applied to a steering wheel using an adhesive that is conventional in the art or through other conventional processes.

First shell 10 has a first surface 12 and a second surface 20. First surface 12 is an exposed outer surface. As shown in FIGS. 1-2, first surface 12 comprises an arc that subtends generally more than about 180°. Second surface 20 is an inner surface configured to engage second shell 38 and to correspond with the outer surface of a steering wheel in order to ensure proper placement of first shell 10 on the desired portion of the steering wheel and to prevent movement of first shell 10 after placement. Referring now to FIG. 1, second surface 20 comprises straight surfaces 14 and angled surfaces 16 that converge to form notches 18. Second surface 20 further comprises projecting surfaces 19, generally straight surfaces 22, and formed surface 24. Projecting surfaces 19 extend from the ends of angled surfaces 16 and comprise edges of projections that are complementary to notches 18. Generally straight surfaces 22 extend from projecting surfaces 19. Formed surface 24 is disposed between generally straight surfaces 22.

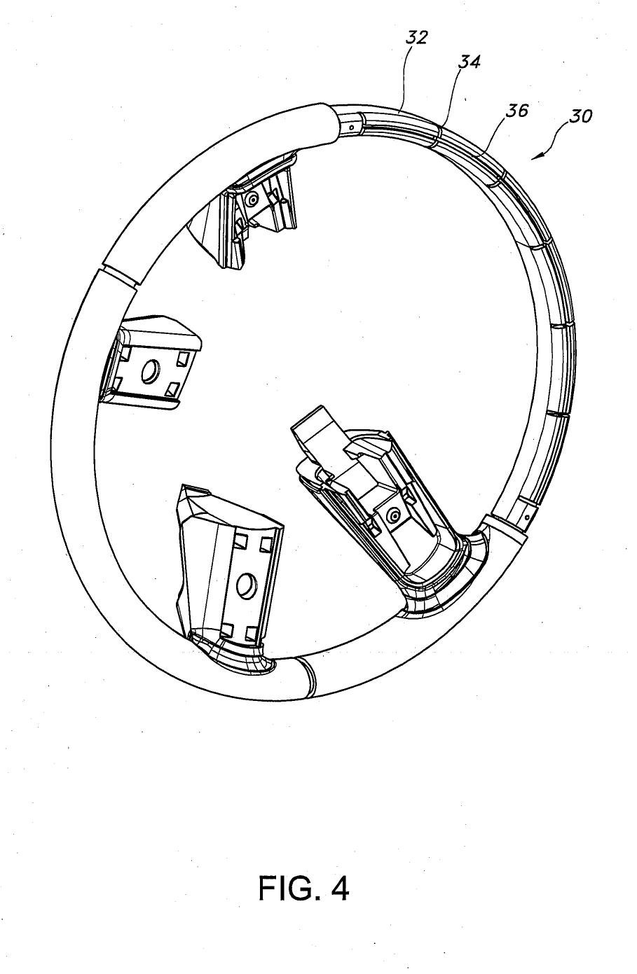

As best viewed in FIG. 2, formed surface 24 may include a radially extending rib 26. In another exemplary embodiment, formed surface 24 may include a plurality of circumferentially spaced, radially extending ribs 26. Rib 26 is provided to correspond with locating features in a first portion of the outer surface of a steering wheel 30. Referring now to FIG. 4, first portion 32 of the outer surface of steering wheel 30 is shown. Outer surface 32 includes locating features that correspond with formed surface 24 of first shell 10. In an exemplary embodiment, one of the locating features is a radially extending groove 34. Groove 34 is configured to receive radially extending rib 26 of first shell 10. In another exemplary embodiment, outer surface 32 of steering wheel 30 may include a plurality of circumferentially spaced, radially extending grooves 34 that are configured to receive a plurality of circumferentially spaced, radially extending ribs 26.

As best viewed in FIG. 2, formed surface 24 may also include a circumferentially extending rib 28. In an exemplary embodiment, circumferentially extending rib 28 may be centered on formed surface 24. In another exemplary embodiment, formed surface 24 may include a plurality of circumferentially extending ribs 28. Rib 28 is provided to correspond with locating features in a first portion of the outer surface of a steering wheel. Referring again to FIG. 4, first portion 32 of the outer surface of steering wheel 30 is shown, including locating features that correspond with formed surface 24 of first shell 10. In an exemplary embodiment, one of the locating features is a circumferentially extending groove 36 that is configured to receive circumferentially extending rib 28 of first shell 10. In another exemplary embodiment, outer surface 32 of steering wheel 30 may include a plurality of circumferentially extending grooves 36 that are configured to receive a plurality of circumferentially extending ribs 28.

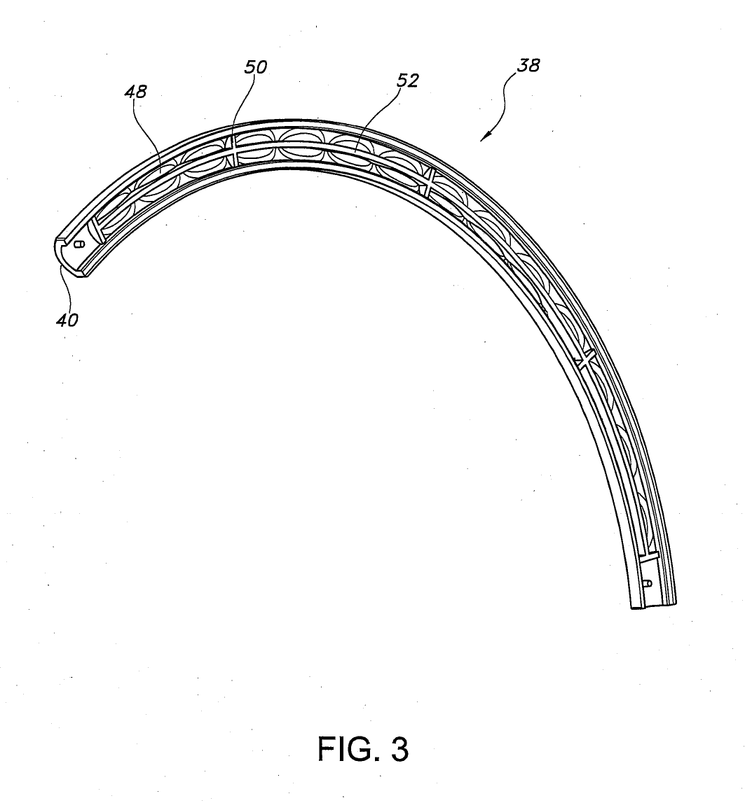

Referring now to FIGS. 1 and 3, second shell 38 is provided to cover a second portion of an outer surface of a steering wheel. Second shell 38 may comprise a polymer. In an exemplary embodiment, second shell 38 may comprise ABS, poly-carbonate ABS, nylon, or polypropylene. It should be understood, however, that material composition and method of manufacture of second shell 38 may be varied without departing from the spirit and scope of the present invention. Second shell 10 may be applied to a steering wheel using an adhesive that is conventional in the art or through other conventional processes.

Second shell 38 has a first surface 40 and a second surface 46. First surface 40 is an exposed outer surface. As shown in FIGS. 1 and 3, first surface 40 comprises an arc that subtends generally less than about 180°. Second surface 46 is an inner surface configured to engage first shell 10 and to correspond with the outer surface of a steering wheel in order to ensure proper placement of second shell 38 on the desired portion of the steering wheel and to prevent movement of second shell 38 after placement. Referring now to FIG. 1, second surface 46 comprises straight surfaces 42 and angled surfaces 44 that converge to form teeth 45 that correspond to notches 18 of first shell 10. Teeth 45 are configured to correspond to notches 18 for mating first shell 10 and second shell 38 in order to prevent splaying of the ends of first shell 10 when first shell 10 is disposed upon a steering wheel 30. In an exemplary embodiment, first shell 10 and second shell 38 may be secured together using an adhesive conventional in the art or through other conventional processes. Second surface 40 further comprises a formed surface 48 disposed between teeth 45.

As best viewed in FIG. 3, formed surface 48 may include a radially extending rib 50. In another exemplary embodiment, formed surface 48 may include a plurality of circumferentially spaced, radially extending ribs 50. Rib 50 is provided to correspond with locating features in a second portion of the outer surface of a steering wheel. Referring now to FIG. 4, a second portion of the outer surface of steering wheel 30 is opposite first portion 32. The second portion of the outer surface of steering wheel 30 includes locating features that correspond with formed surface 48 of second shell 38. In an exemplary embodiment, one of the locating features is a radially extending groove (not shown) similar to groove 34. The radially extending groove (not shown) is configured to receive radially extending rib 50 of second shell 38. In another exemplary embodiment, the second portion of the outer surface of steering wheel 30 may include a plurality of circumferentially spaced, radially extending grooves (not shown) similar to grooves 34 that are configured to receive a plurality of circumferentially spaced, radially extending ribs 50.

As best viewed in FIG. 3, formed surface 48 may also include a circumferentially extending rib 52. In an exemplary embodiment, circumferentially extending rib 52 may be centered on formed surface 48. In another exemplary embodiment, formed surface 48 may include a plurality of circumferentially extending ribs 52. Rib 52 is provided to correspond with locating features in a second portion of the outer surface of a steering wheel. Referring again to FIG. 4, a second portion of the outer surface of steering wheel 30 that is opposite first portion 32 includes locating features that correspond with formed surface 48 of second shell 10. In an exemplary embodiment, one of the locating features is a circumferentially extending groove (not shown) similar to groove 36 that is configured to receive circumferentially extending rib 52 of second shell 38. In another exemplary embodiment, the second portion of the outer surface of steering wheel 30 may include a plurality of circumferentially extending grooves (not shown) similar to groove 36 that are configured to receive a plurality of circumferentially extending ribs 52.

Referring again to FIG. 3, second shell 38 is disposed adjacent to first shell 10 when placed on steering wheel 30. Outer surface 12 of first shell 10 and outer surface 40 of second shell 38 together comprise an arc subtending approximately 360° and cover an entire outer surface of steering wheel 30. In an exemplary embodiment, only outer surface 12 of first shell 10 may be visible in at least one view of wheel 30 to which shells 10 and 38 have been applied. For example, only first shell 10 may be visible in a driver's line of sight as he or she operates steering wheel 30 in a motor vehicle. Further, in an exemplary embodiment, the seam or mating of first shell 10 and second shell 38 is not visible in at least one view of wheel 30 to which shells 10 and 38 have been applied. For example, the seam or meeting of first shell 10 and second shell 38 may not be visible in a driver's line of sight as he or she operates steering wheel 30 in a motor vehicle.

Before first shell 10 or second shell 38 are applied to a steering wheel 30, the first shell 10 or second shell 38 may be decorated with paint, hydrographic ink coating, wood veneer, leather, or an in-mold film application. Although these decorating processes are listed in detail, it is understood by those of ordinary skill in the art that numerous other decorating or ornamentation processes may be utilized and remain within the spirit and scope of the invention.

Although second shell 38 is described in detail, it is understood by those of ordinary skill in the art, that only first shell 10 may be secured to a steering wheel 30 in another exemplary embodiment.

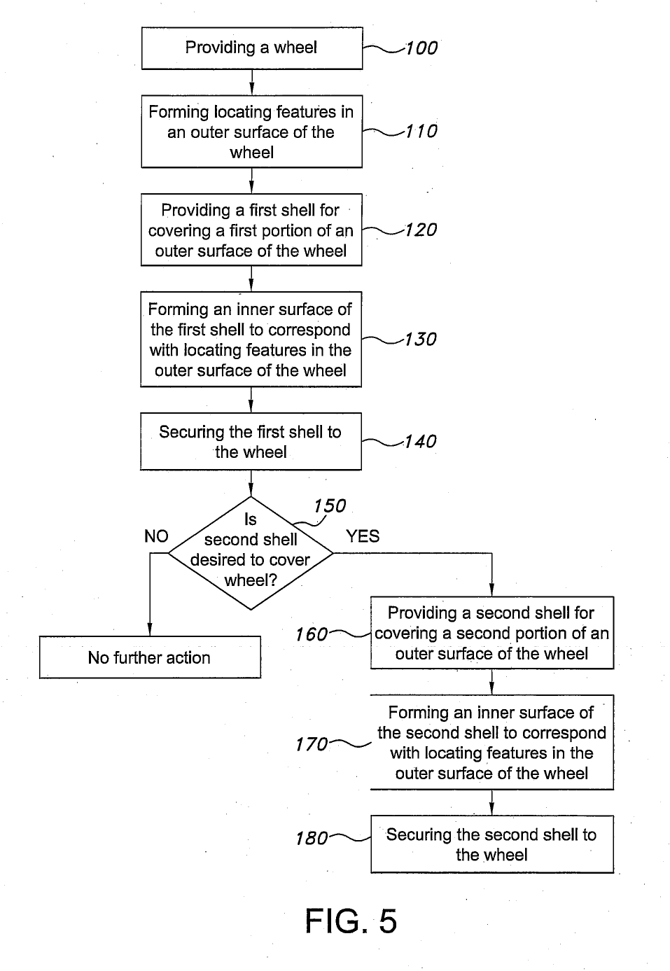

A method for covering a steering wheel in accordance with the present invention includes the following steps, and a flow chart is illustrated in FIG. 5. First, a steering wheel is provided in step 100. Locating features, such as radially extending and circumferentially extending ribs, are formed in the outer surface of the wheel in step 110. A first shell is provided for covering a first portion of an outer surface of the wheel in step 120. An inner surface of the first shell is formed to correspond with the locating features in an outer surface of the wheel in step 130. For example, the inner surface of the first shell may include radially extending and circumferentially extending ribs that correspond with grooves in the outer surface of the wheel. The first shell is then secured to the wheel in step 140. A determination must be made as to whether a second shell is desired to cover the wheel in step 150. If no second shell is desired, then no further steps are necessary. However, if a second shell is desired, the method for covering a steering wheel may further include providing a second shell for covering a second portion of an outer surface of the wheel in step 160. An inner surface of the second shell is formed to correspond with the locating features in an outer surface of the wheel in step 170. For example, the inner surface of the second shell may include radially extending and circumferentially extending ribs that correspond with grooves in the outer surface of the wheel. The second shell is then secured to the wheel adjacent to the first shell in step 180.

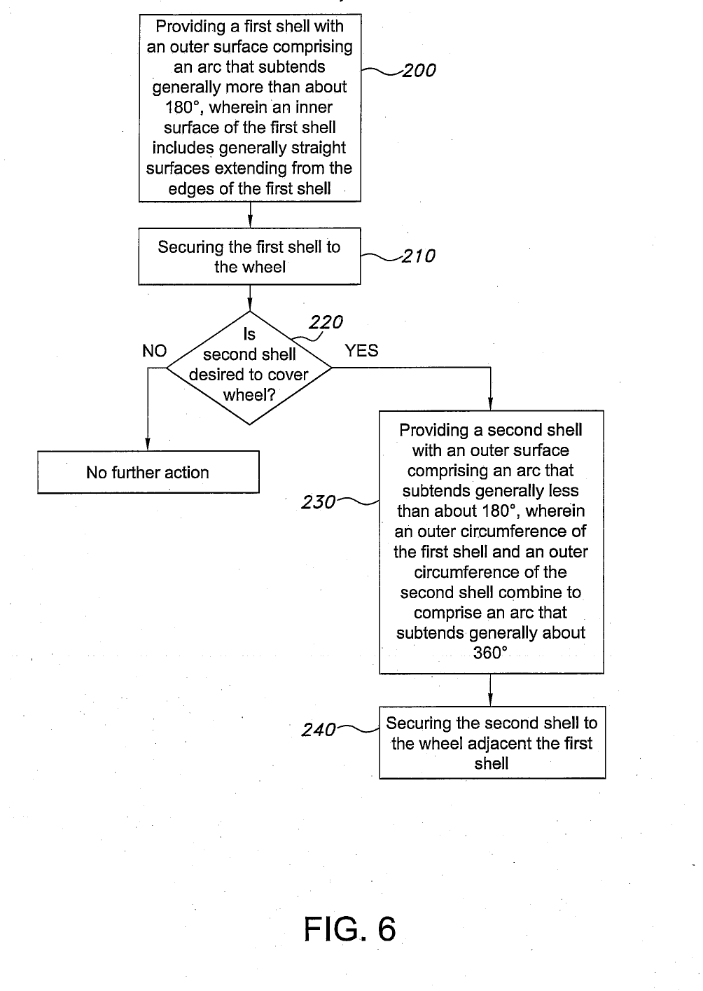

Another method for covering a steering wheel in accordance with the present invention includes the following steps, and a flow chart is illustrated in FIG. 6. A first shell with an outer surface comprising an arc that subtends generally more than about 180° is provided in step 200. An inner surface of the first shell includes generally straight surfaces extending from the edges of the first shell. The first shell is then secured to the wheel in step 210. A determination must be made as to whether a second shell is desired to cover the wheel in step 220. If no second shell is desired, then no further steps are necessary. However, if a second shell is desired, the method for covering a steering wheel may further include providing a second shell with an outer surface comprising an arc that subtends generally less than about 180° in step 230. An outer surface of the second shell and an outer surface of the first shell combine to comprise an arc that subtends generally about 360°. The second shell may then be secured to the wheel adjacent to the first shell in step 240. In this exemplary method, the first shell may include notches proximate to the edges of the first shell, and the second shell may include teeth corresponding to the notches for mating the first and second shells and preventing the edges of the first shell from splaying after the first and second shell are secured to the wheel.

While the invention has been shown and described with reference to one or more particular embodiments thereof, it will be understood by those of skill in the art that various changes and modifications can be made in the invention without departing from the spirit and scope of the invention.

We claim:

1. A covering for a steering wheel comprising:
a first shell for covering a first portion of an outer surface of said wheel, said first shell having an outer surface comprising an arc that subtends generally more than about 180° and having an inner surface configured to correspond with said first portion of said outer surface of said wheel.

2. A covering in accordance with claim 1, further comprising:
a second shell for covering a second portion of said outer surface of said wheel, said second shell configured to be disposed adjacent to said first shell, having an outer surface comprising an arc that subtends generally less than about 180°, and having an inner surface configured to correspond with said second portion of said outer surface of said wheel.

3. A covering in accordance with claim 2, wherein edges of said first shell and said second shell meet.

4. A covering in accordance with claim 2, wherein said first shell and said second shell together cover an entire outer surface of said wheel.

5. A covering in accordance with claim 1, wherein said inner surface of said first shell is formed to correspond with locating features in said first portion of said outer surface of said wheel.

6. A covering in accordance with claim 5, wherein said inner surface of said first shell includes a radially extending rib.

7. A covering in accordance with claim 5, wherein said inner surface of said first shell includes a plurality of circumferentially spaced radially extending ribs.

8. A covering in accordance with claim 5, wherein said inner surface of said first shell includes a circumferentially extending rib.

9. A covering in accordance with claim 5, wherein one of said locating features is a radially extending groove.

10. A covering in accordance with claim 5, wherein one of said locating features is a circumferentially extending groove.

11. A covering in accordance with claim 2, wherein said inner surface of said second shell is formed to correspond with locating features in said second portion of said outer surface of said wheel.

12. A covering in accordance with claim 1, wherein said first shell comprises a polymer.

13. A covering in accordance with claim 12, wherein said first shell comprises one of ABS (copolymer of acrylonitrile, butadiene, and styrene), poly-carbonate ABS, nylon, and polypropylene.

14. A covering in accordance with claim 2, wherein a notch in said first shell and a tooth corresponding to said notch in said second shell are configured to lock said first shell and said second shell together.

15. A covering in accordance with claim 2, wherein a decorative process is applied to said first shell and said second shell.

16. A method for covering a steering wheel, comprising the following steps:
providing said wheel;
forming locating features in an outer surface of said wheel;
providing a first shell for covering a first portion of an outer surface of said wheel;
forming an inner surface of said first shell to correspond with said locating features in said outer surface of said wheel; and
securing said first shell to said wheel.

17. A method for covering a steering wheel in accordance with claim 16, further comprising the steps of:
providing a second shell for covering a second portion of said outer surface of said wheel;
forming an inner surface of said second shell to correspond with said locating features in said outer surface of said wheel; and
securing said second shell to said wheel adjacent to said first shell.

18. A method for covering a steering wheel, comprising the following steps:
providing a first shell with an outer surface comprising an arc that subtends generally more than about 180°, wherein an inner surface of said first shell includes generally straight surfaces extending from the edges of said first shell; and
securing said first shell to said wheel.

19. A method for covering a steering wheel in accordance with claim 18, further comprising the following steps:
providing a second shell with an outer surface comprising an arc that subtends generally less than about 180°, wherein an outer surface of said second shell and an outer surface of said first shell combine to comprise an arc that subtends generally about 360°; and
securing said second shell to said wheel adjacent said first shell.

20. A method for covering a steering wheel in accordance with claim 19, wherein said first shell includes notches proximate said edges of said first shell and wherein said second shell includes teeth corresponding to said notches for preventing said edges of said first shell from splaying after said first and second shell are secured to said wheel.
